(19) United States
(12) Patent Application Publication
(10) Pub. No.: US 2006/0180732 A1
(43) Pub. Date: Aug. 17, 2006

(54) Cardboard concrete forming system

(76) Inventor: Mark A. Lawrence, Black Creek (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/336,921

(22) Filed: Jan. 23, 2006

(30) Foreign Application Priority Data
Feb. 2, 2005 (CA) 2,495,955

(51) Int. Cl. E04G 13/00; B32B 29/08

(52) U.S. Cl. 249/34; 428/542.8

(57) ABSTRACT

A concrete form and forming system beginning as a flat cardboard sheet, the sheet being pre-creased to allow a user to easily fold the sheet into a form for accepting poured concrete, The form may have measuring indicia marked on it for easy measuring, and has holes formed in it for accepting rebar which may be introduced into the form to stabilize both the form and the eventual concrete foundation. In one embodiment the form has an upside-down T-shape.

### TECHNICAL FIELD

The present invention relates to concrete forms, and more particularly to concrete forming systems which may be easily constructed by a user and which do not need to be removed after concrete is poured.

### BACKGROUND

Traditionally, to define a perimeter of a given area to be poured with concrete during construction, a “concrete form” or concrete perimeter-setting system using temporary forms is erected or installed. Once the form has been built, uncured concrete is then poured thereinto, forming foundations and walls and the like once the concrete cures.

Concrete forms have traditionally been made from wood. Other, newer concrete forms are made from metals such as aluminum or synthetic materials such as plastic and styrofoam.

Wooden concrete forms are traditionally constructed from boards on-site. They are heavy, bulky and difficult to work with for those who do not have experience working with wood. The boards are usually installed with a number and variety of stakes nailed to the boards to hold them in place.

Wooden forms are most often dismantled once the concrete has cured, since it is not desirable to keep the form in place for a variety of reasons. The wood may then be recycled, although it is often rendered otherwise unusable and is discarded.

Because a relatively good knowledge of or experience in carpentry is required to build and dismantle such wooden forms (and similar forms made from other materials such as aluminum), the idea of framing a traditional wooden concrete form can cause particular anxiety to a “do-it-yourselfer” who is attempting to pour a foundation for even a simple construction project, such as a fence or a shed.

There remains, accordingly, a need for a simple concrete forming system that may be easily erected by a relatively inexperienced user and which does not necessarily need to be dismantled after curing of the concrete in the form.

### SUMMARY OF INVENTION

The present invention is a concrete form and forming system which may be purchased and used by anyone, but which may be particularly useful to those without the knowledge or expertise or desire to erect a traditional wooden concrete form.

The form itself, in a preferred embodiment, is made from a sheet of corrugated cardboard having a predetermined length and width, the cardboard sheet being pre-creased or pre-scored to allow a user to fold the sheet length-wise into the shape of a trough for accepting poured uncured concrete. The trough has, when the form is completed, a generally upside-down T-shape, in a preferred embodiment.

More particularly, the form has a bottom, two lower side walls extending upwardly from the bottom; two intermediate portions, each extending inwardly from the top of one of said lower side walls toward one another, the intermediate portions each having an outer end and an inner end; two upper side walls, each extending upwardly from an inner end of one of the intermediate portions; and two top flap portions, each one extending outwardly from the top of one of said upper side walls.

In a preferred embodiment of the invention, the cardboard is waxed to limit any disintegration from the cardboard from the wet concrete poured into the form. In a further preferred embodiment, the top flap portions, the intermediate portions, and preferably, the bottom all have holes formed therethrough to allow rebar to be positioned within the form. Along with the rebar added to the form, the forming system may further have end cap portions for closing off the ends of the forms, and may have corner pieces for attaching two forms together at a desired angle. Clips may be provided to add strength to the form laterally if required.

In the preferred embodiment of the invention, measuring indicia are pre-printed on the cardboard sheet to allow easy measuring by a user without the need for the use of a tape measure.

### BRIEF DESCRIPTION OF DRAWINGS

It will be appreciated that the particularized description of the invention described briefly above and which follows hereafter is rendered by reference to certain specific embodiments of the invention which are illustrated in the appended drawings. The drawings depict only one typical embodiment of the invention and are not therefore to be considered to be limiting of the scope of the invention.

Accordingly, in the accompanying drawings which illustrate a specific embodiment of the invention, but which should not be construed as restricting the spirit or scope of the invention in any way:

FIG. 1 is a top plan view of a cardboard sheet made in accordance with one embodiment of the present invention.

FIG. 2 is a perspective view of one embodiment of the concrete form of the present invention, made from the cardboard sheet shown in FIG. 1.

FIG. 3 is an end view of one embodiment of the concrete form system of the present invention.

FIG. 4 is a close-up top view of a portion of the form system shown in FIG. 3.

FIG. 5 is a top view of another embodiment of the concrete form system of the present invention, showing a corner formed by two concrete forms having been adjoined at right angles, and showing an end cap.

FIG. 6 is a top plan view of a cardboard sheet made in accordance with another embodiment of the present invention.

FIG. 7 is an end view of another embodiment of the concrete form system of the present invention.

FIG. 8 is a close-up top view of a portion of a hybrid of the form systems shown in FIG. 3 and FIG. 7.

FIG. 9 is an end view of another embodiment of the concrete form system of the present invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

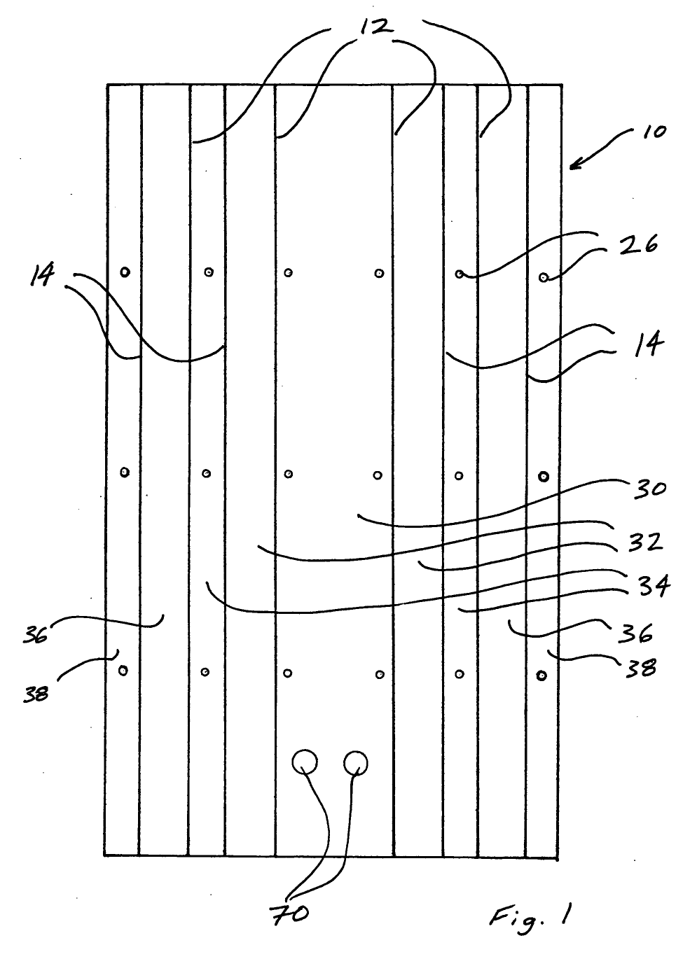

Referring first to FIG. 1, the present invention provides, in a preferred embodiment, a sheet of cardboard, referred to generally herein by reference numeral “10”. Cardboard sheet 10 is preferably corrugated for added strength, and may also be waxed or otherwise chemically treated to limit the effect of the wet concrete on the structural integrity of the cardboard.

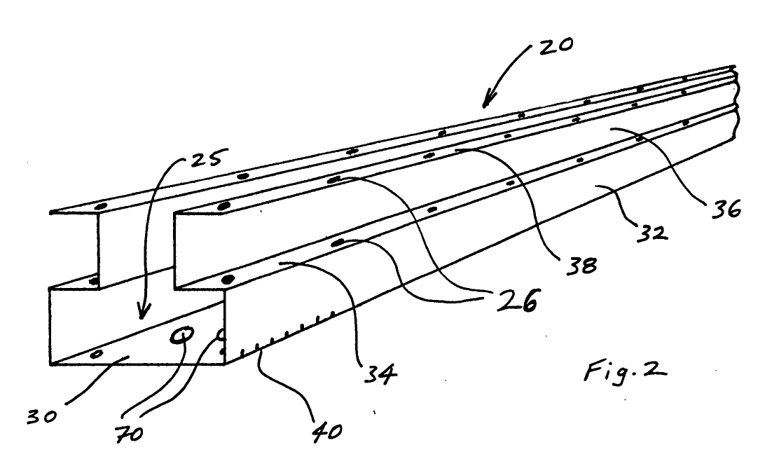

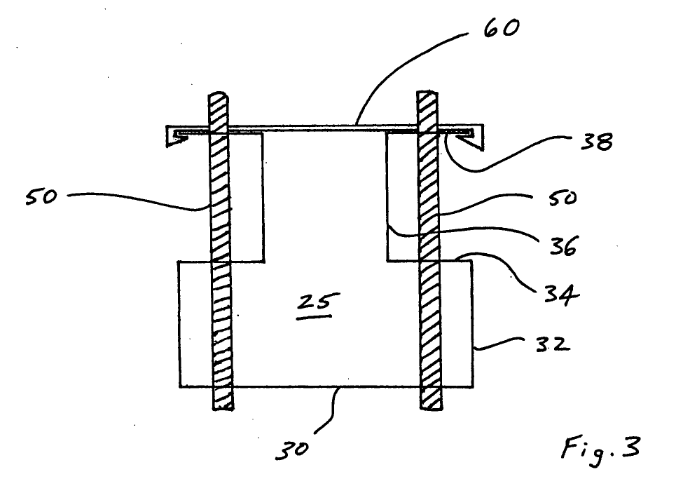

Sheet 10 has creases 12 and 14, which are administered to sheet 10 before sheet 10 is sold to an end-user (ie. the sheet is “pre-creased”). Creases 12 and 14 allow a user of sheet 10 to form sheet 10 into a form 20 (FIG. 2) for pouring uncured concrete into. Concrete form 20 may take the general shape of an upside-down “T”, as shown in FIGS. 2 and 3.

It will be appreciated that to construct form 20, a user would fold sheet 10 “inwardly” along creases 12, and “outwardly” along creases 14, and accordingly creases 12 and 14 would preferably be creased (or scored, as discussed below) into opposite faces of sheet 10. Forms 20 might be pre-constructed before being sold to an end-user, but it is foreseen by the inventor that one advantage to the present system is that the sheet 10, while unfolded, is both light and easy to ship, transport and otherwise handle, especially for a non-professional user, which provides great advantage over prior art forming systems.

When sheet 10 is folded into form 20 (FIG. 2), form 20 can be said to have a bottom 30 with lower side walls 32 extending upwardly therefrom. Lower side walls 32 as illustrated are the same height, but need not be.

At the tops of lower side walls 32, intermediate portions 34 extend inwardly from walls 32 to the bottoms of upper side walls 36. It will be clear that the sum of the widths of intermediate portions 34 should be less than the width of bottom 30, but there is no particular proportion of relative widths which the inventors have deemed necessary for the ultimate efficiency of the form.

Accordingly, upper side walls 36 extend upwardly from the inner ends of intermediate portions 34, and at their respective tops, top “flap” portions 38 extend outwardly again, as shown in FIG. 2. In the form 20 illustrated in the figures, flap portions 38 are the same width as intermediate portions 34, and thus overlap them exactly when viewed from above, although it is not necessary to have any of side walls 32 (as previously discussed) or 36, or intermediate portions 34 or flap portions 38 be the same height or width as any other portion of the form.

So, when constructed by a user, form 20 as illustrated generally has an upside-down T-shape. Form 20 thus defines a trough 25 into which uncured concrete may be poured as desired once form 20 has been placed into a desired position by a user.

It is very likely, it would be thought, that such a form, unless constructed of very heavy cardboard, would tend to bow open when concrete is introduced thereto, due to the weight of the concrete pushing outwardly on walls 32, 36. To accommodate the force of the concrete on the form, the sheet 10 is provided with holes 26 formed therethrough at various positions. It will be seen from FIGS. 1 and 2 that these holes are formed in what will become the top flap portions 38 and intermediate portions 34 of the form. Holes 26 are preferably positioned to be generally coaxial when form 20 is constructed, thereby allowing one or more bars (rebar 50) to be introduced into the form generally vertically, tending to hold the form together laterally. In a preferred embodiment, holes 26 are also formed through what will become the bottom 30 of the form 20, allowing the rebar to pass through the form entirely (as shown in FIG. 3), tending to stabilize the form further, and tending to stabilize the form with respect to the ground or other surface on which it sits.

The rebar thus serves the purpose of not only holding form 20 together, but also strengthens, in the traditional manner, the concrete which is introduced into trough 25, and which eventually cures. Rebar could also be introduced to the form in a horizontal orientation if desired, either by preforming forming holes in sheet 10, or by a user cutting appropriate holes in the cardboard form 20 once it is in place to accept concrete. of course, in addition to rebar 50, a reinforcing mesh made of steel, wire, plastic or other material could be introduced to form 20.

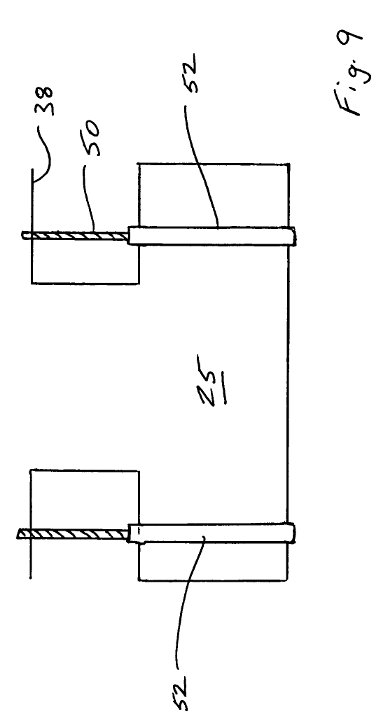

As discussed above, rebar 50 can be passed through form 20 entirely as shown in FIG. 3 to stabilize form 20, and the eventual concrete wall formed therein, with respect to the ground on which the form sits. Additionally, larger holes 70 (FIGS. 1 and 2) can also be formed in the bottom of form 20, which holes 70 will allow concrete to seep out of form 20 to some extent, providing further stability once cured. In another embodiment, shown in FIG. 9, sheaths such as cylinders 52 may be provided to permanently stay within form 20. In this instance, rebar 50 may be inserted into cylindrical sheaths 52 while the form is filled with concrete, and thereafter removed.

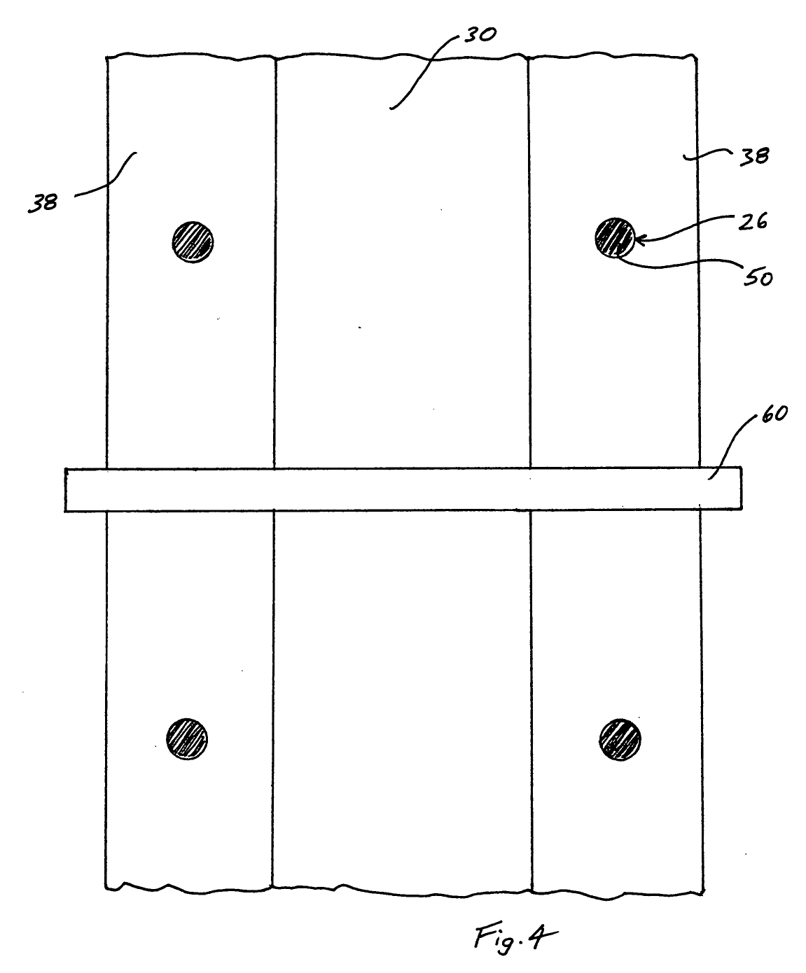

In the alternative, or preferably in addition to rebar 50, the top of form 20 may be held together by spanning one or more clips 60 (FIGS. 3 and 4) across the top of the form. In the illustrated embodiment of the invention, the clips 60 are clipped to the outer edges of flap portions 38 of the form 20.

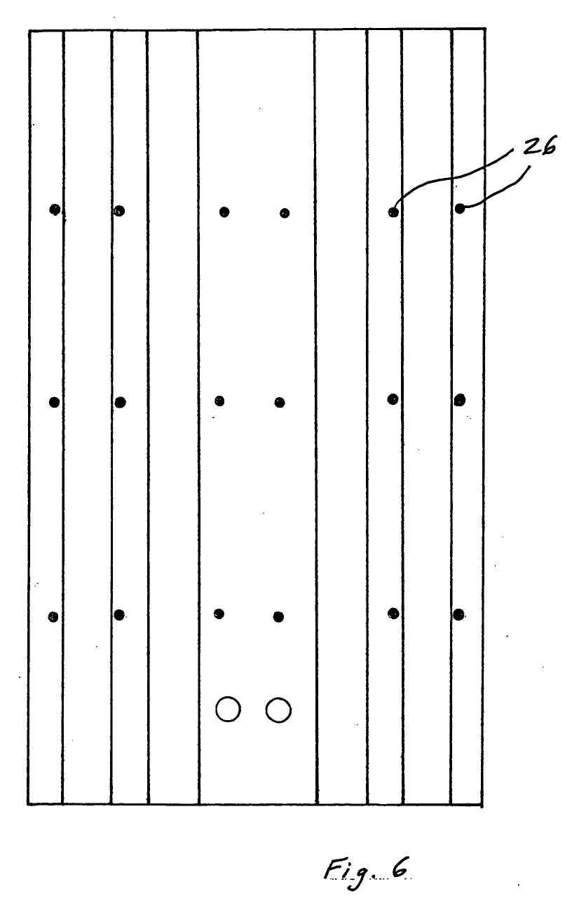

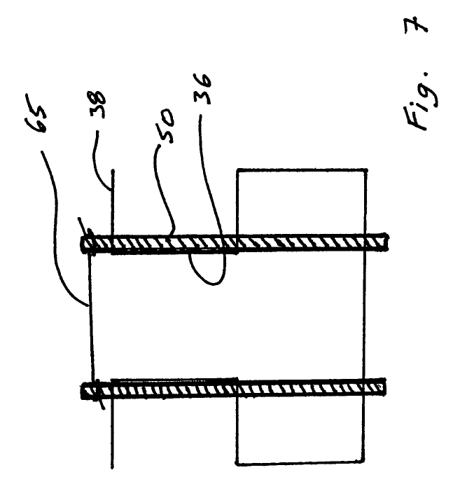

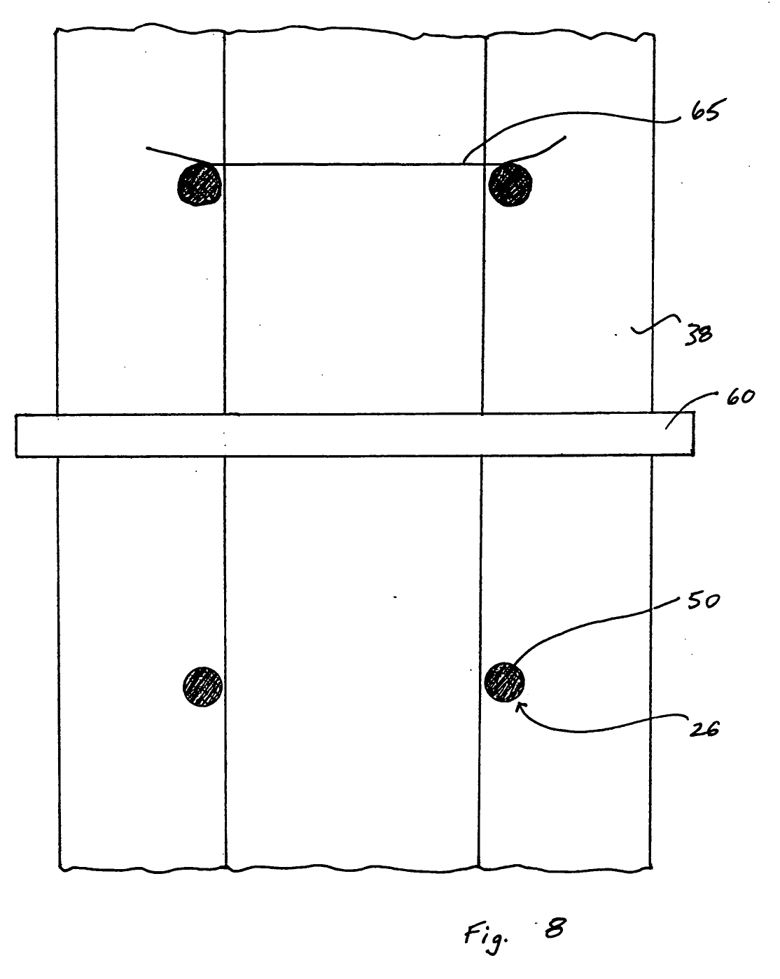

An alternative embodiment of the forming system is shown in FIGS. 6-8. In this embodiment, holes 26 are formed very near the creases 12, 14, such that when form 20 is constructed, rebar 50 passing through the form abuts (sits flush with) or very nearly abuts upper side walls 36, lending walls 36 an extra degree of support. In one embodiment of the invention (FIG. 7), two laterally adjacent pieces of rebar 50 can be tied across the form 20 with wire ties 65 or plastic ties or similar tie material to prevent bowing of the rebar and vertical walls outwardly. It will be appreciated that such ties 65 can be placed at the top of the form, or at any length of the rebar 50. Or, as shown in FIG. 8, a combination of ties 65 and clips 60 may be used to stabilize the form 20.

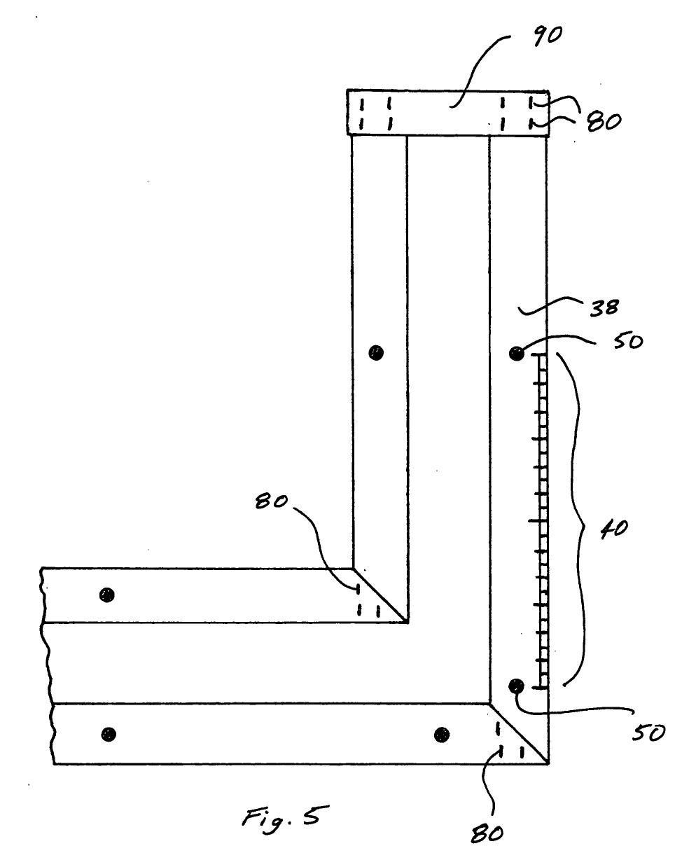

It will be appreciated that in many instances it is useful to pass plumbing and electrical wiring and other such hardware through the concrete foundation or wall which will be formed by form 20. The form 20, since it is made from cardboard, is easily cuttable, and such hardware can be put in place through form 20 very easily. For this reason among others, the present form 20 may advantageously be provided with measuring indicia 40 marked or pre-printed on sheet 10. Such indicia provides a user with an easy ability to measure the lengths of the forms 20, and also to appropriately position and locate pipes, electrical conduit, and the like through form 20. Such indicia 40 could be printed on any appropriate surface of form 20. In FIG. 2, such indicia (shown only partially) are shown printed on a lower side wall 32, and in FIG. 5 such indicia are shown printed on a top flap portion 38.

The indicia illustrated in FIG. 5 are intended to reflect a measurement of twenty-four inches, and the rebar shown in FIG. 5 are accordingly shown to be two feet apart. However, the relative distance between bars of rebar that might be required to be used is not crucial to the invention.

It will of course be appreciated that unless the ends of forms 20 are closed, thereby enclosing trough 25, concrete introduced into the form will simply tend to flow out of the form. Accordingly, the system of the invention provides end caps 90 (FIG. 5) which may be attached to the ends of the forms 20. In FIG. 5, end cap 90 is stapled to the end of form 20 by staples 80, although a wide variety of fastening means could be employed.

It will also be appreciated that forms 20 will necessarily be of a discrete size and shape, depending upon the size of sheet 10. It will be appreciated that two forms could easily be attached to one another end-to-end (not shown) to form a longer form. To attach two forms together to form a corner, the system foresees the provision of pre-formed corner pieces (not shown). Alternatively, corners could be formed by appropriate cutting of the ends of two forms as shown in FIG. 5. In FIG. 5, two forms are joined together again by staples 80, with at least some portion of the respective top flap portions 38 of two forms overlapping.

Once the poured concrete cures in the form 20, the form may be removed, or may be left in place. It is foreseen that sheet 10 of form 20 could be provided with a textured surface, to give the eventual concrete surface a texture, so as to, for example, have the concrete imitate or simulate stone.

As will be apparent to those skilled in the art in the light of the foregoing disclosure, many alterations and modifications are possible in the practice of this invention without departing from the spirit or scope thereof. For instance, although the present disclosure of the invention refers to concrete throughout, the form can be used for forming any curable material such as cement, asphalt, plastic, etc. Also, for example, the form illustrated in the figures is shown to be symmetrical. However, it need not necessarily be so, and any of the heretofore discussed walls, intermediate portions or flaps may be of any suitable length to provide a trough having a desired shape. Further, while cardboard is referred to as a preferred material for sheet 10, other materials could be used as long as they have the appropriate strength in addition to being able to be folded by a user as described.

Accordingly, the scope of the invention is to be construed in accordance with the substance defined by the following claims.

What is claimed is:

1. A concrete form comprising:
(a) a sheet of corrugated cardboard having a predetermined length and width, said cardboard sheet being pre-creased to allow a user to fold said sheet length-wise into a trough for accepting poured concrete, said trough being bounded by:
(i) a bottom;
(ii) two lower side walls extending upwardly from said bottom;
(iii) two intermediate portions, each extending inwardly from the top of one of said lower side walls toward one another, said intermediate portions each having an outer end and an inner end;
(iv) two upper side walls, each one extending upwardly from an inner end of one of said intermediate portions; and
(v) two top flap portions, each one extending outwardly from the top of one of said upper side walls, the trough thus having an upside-down T-shape.

2. The concrete form of claim 1, wherein the cardboard is waxed.

3. The concrete form of claim 2, further comprising one or more holes formed through each of said intermediate portions and said top flap portions, said holes relatively positioned to be generally coaxial when said form is constructed, said holes allowing rebar to be introduced into said form, passing generally vertically thereinto from the top of said form.

4. The concrete form of claim 3, further comprising one or more holes formed through said bottom, said holes allowing said rebar to extend from the top of said form through said bottom of said form.

5. The concrete form of claim 3 further comprising clips for clipping together the edges of said top flap portions.

6. The concrete form of claim 3 further comprising measuring indicia printed on said sheet.

7. The concrete form of claim 1, wherein said cardboard sheet is pre-scored rather than pre-creased.

8. The concrete form of claim 3, further comprising holes formed through said bottom of said form for allowing concrete to seep therethrough.

9. A concrete forming system comprising:
a. the concrete form of any one of claims 1 to 8; and
b. a plurality of bars of rebar, each bar passing through two or more of said holes formed in said form.

10. The concrete forming system of claim 9, further comprising an end cap for enclosing an end of said form.

11. The concrete forming system of claim 10, further comprising a corner piece for attaching two of said forms together at their ends.

12. The concrete form of claim 9 further comprising bars of rebar passing through said form horizontally.

13. The concrete form of claim 9 wherein said bars of rebar are spaced at 2-foot intervals.

14. The concrete form of claim 1 wherein said form is laterally symmetrical.

15. The concrete form of claim 1 where said sheet has a textured surface.

16. The concrete form of claim 9 further comprising wire ties for tying together two laterally-adjacent pieces of rebar.

17. The concrete form of claim 1 wherein said trough includes sheathes passing at least partially therethrough for allowing rebar to be removably introduced into said form.
